(19) United States
(12) Patent Application Publication
(10) Pub. No.: US 2010/0277369 A1
(43) Pub. Date: Nov. 4, 2010

(54) MICROWAVE COUPLER

(76) Inventors: David John Gunton, Chelmsford (GB); Arthur Glyn Stacey, Chelmsford (GB)

Correspondence Address: KENYON & KENYON LLP, ONE BROADWAY, NEW YORK, NY, 10004, US

(21) Appl. No.: 12/306,517

(22) PCT Filed: Nov. 24, 2008
(86) PCT No.: PCT/GB08/51099

§ 371 Date: Jun. 17, 2010

(30) Foreign Application Priority Data
Dec. 21, 2007 (EP) 07270079.2
Dec. 21, 2007 (GB) 0724912.1

(51) Int. Cl. H01Q 3/00; H01P 5/18

(52) U.S. Cl. 342/368; 333/111

(57) ABSTRACT

The present invention relates to directional couplers for microwave signals, and in particular to a combline directional coupler (301) for use at millimetre wavelengths. The combline microwave coupler (301) comprises a first transmission line (202), and a second transmission line (203), each transmission line including along its length a series of stubs (206, 207), the stubs of the first and second transmission lines being oriented in a combline pattern with each other such that in use microwave energy passing along one transmission line is coupled to the other. The coupler also includes four ports one at each end of the transmission lines for coupling microwave signals into or from said transmission lines, including at the first end of the combline pattern a first port to the first transmission line, and a second port to the second transmission line, and including at the second end of the combline pattern a third port to the first transmission line and a fourth port to the second transmission line. The phase difference between the signals appearing at the output ports is characteristic of a symmetry parameter of said transmission lines related to the difference in the propagation characteristics of microwave energy in the two coupled transmission lines. The coupler (301) comprises additionally means (30) for altering this symmetry parameter, for example by lengthening individual stubs (206), in order to control the relative phases of microwave signals coupled out of the two output ports when a microwave signal is coupled into one of the ports at the first end of the combline structure.

### BACKGROUND

a. Field of the Invention

The present invention relates to directional couplers for microwave signals, and in particular to a combline directional coupler for use at millimetre wavelengths.

2. Related Art

Directional couplers, including power dividers, are passive devices used in the field of radio technology. They couple part of the transmission power in a transmission line by a known amount out through another port, often by using two transmission lines set close enough together such that energy passing through one is coupled to the other. Directional couplers take many forms. Some couplers, referred to as hybrid couplers or 3 dB directional couplers receive one input and provide two outputs of equal amplitude and with a fixed phase relationship. It is also possible to design couplers having unequal amplitudes at two outputs.

Couplers having a variable phase delay at two outputs have historically been difficult to achieve. At frequencies where coaxial components can be used, and where space is not a constraint, sliding contact techniques are effective, either in an in-line or folded configuration. Both manual and motorised versions of these can be used in laboratory test equipment to move a measurement ‘reference plane’ to an arbitrary position with respect to the circuit under test.

In the microwave band, electronically switched phase shifters have been obtained by a combination of a set of fixed line lengths and p-i-n switches. The use of electronic switches invariably introduces unwanted loss, while the implementation of such an approach becomes more difficult at higher frequencies, at which the losses increase further. Furthermore, the quantised nature of the resultant phase delay limits the usefulness of the component. Continuously variable phase shifters have been produced, based on the use of varactors to provide a variable complex impedance at the ports of a coupler, but they are most effective at frequencies below 30 GHz.

An important application of electronic phase shifters is in the field of steerable antenna arrays. There is a growing need to achieve control of the beam direction in antennas operating in the millimetric band (e.g. 40 to 100 GHz), for example in automotive radar vehicle guidance applications. In this band, switched options are lossy, an aspect made more significant by the difficulty and expense of producing power in this band.

### SUMMARY OF THE INVENTION

According to the invention, there is provided a combline microwave directional coupler, comprising:
a first transmission line, and a second transmission line, each transmission line including along its length a series of stubs, the stubs of the first and second transmission lines being oriented in a combline pattern with each other such that in use microwave energy passing along one transmission line is coupled to the other, the transmission lines extending between a first end of the combline pattern and an opposite second end of the combline pattern;
four ports one at each end of said transmission lines for coupling microwave signals into or out of said transmission lines, including at the first end of the combline pattern a first input port to the first transmission line, and a second input port to the second transmission line, and including at the second end of the combline pattern a third output port to the first transmission line and a fourth output port to the second transmission line;

wherein
the phase difference between the signals appearing at the output ports is characteristic of a symmetry parameter of said transmission lines related to the difference in the propagation characteristics of microwave energy in the two coupled transmission lines;
the combline microwave directional coupler comprises additionally means for altering said symmetry parameter in order to control the relative phases of microwave signals coupled out of said two ports at the second end of the combline structure when a microwave signal is coupled into one of said ports at the first end of the combline structure.

In general, the relative amplitudes of the microwave signals coupled out of the output ports will also vary according to the change of the symmetry parameter.

It is to be noted that a directional coupler operates in an essentially linear fashion with respect to the input signals, so that the outputs which are found when signals are applied to both input ports are obtained by a vector sum of the outputs which would have been obtained when each input signal was applied separately.

However, it will often be the case that an input signal will be applied to only to one of the two input ports.

Also according to the invention, there is provided a microwave circuit, comprising a source of microwave energy and a combline microwave directional coupler according to the invention, the first input port being arranged to receive microwave energy from said source of microwave energy. The source of microwave energy is preferably a millimetre band source of microwave energy.

The invention further provides a phased array radar system, comprising a radar transmitter having at least two transmitting elements for transmitting radar signals, and at least one combline microwave directional coupler according to the invention, in which said transmitting elements are connected to different output ports of said directional coupler(s) so that in use the direction of radar signals transmitted by the transmitting elements can be controlled by controlling the relative phases of the microwave signals coupled out of said output ports.

In general the degree of coupling between the first and second transmission lines, and therefore the relative phases of microwave signals coupled out of the output ports, will depend on the frequency of the input microwave energy. Although the coupler will most commonly be incorporated in a device operating at a fixed frequency, the invention is also applicable to devices where the operating frequency is not fixed. In this situation, there may be a variation in phase difference with frequency, and a means can be provided so that the coupler symmetry is varied in a way which will substantially reduce the frequency-dependence of the output phase difference.

The combline pattern may take various different forms, depending on factors such as the microwave frequency or band of frequencies of operation, the desired relative power split between the two output ports of the coupler, and the desired range of phase shifts at the output ports. In one type of combline pattern, at least some of the stubs extend from one transmission line towards the other transmission line. In general, each transmission line will have an elongate conducting element extending between the opposite ends of the combline pattern. Stubs will then project transversely relative to the length of the elongate element. Such stubs can project so far so as to be interleaved, and preferably alternately interleaved with other stubs extending in an opposite direction from the opposite transmission line.

However, some or all of the stubs may take other forms and may, for example, extend from at least one of the transmission lines in a direction away from the other transmission line to form what is referred to in the art as a herringbone combline pattern.

Preferably, the combline microwave directional coupler comprises additionally at least one movable component which in use is electromagnetically coupled with microwave energy in one or both of said transmission lines. The means for altering the symmetry parameter is then a mechanical means for moving the or each movable component in order to alter relative coupling of microwave energy between the first and second transmission lines and thereby control the relative phases of the output microwave signals.

Broadly speaking, the movable means can control the relative coupling by changing geometry, orientation or spacing between different conductive or dielectric components associated with either or both of the transmission lines.

Millimetre band microwaves typically span the frequency region from 30 to 300 GHz. In this frequency region, and by way of example only, the dimensions of a combline coupler designed to operate at around 60 GHz may typically be approximately 5 mm in length between the opposite ends of the combline pattern, and about 1 mm in width across the combline pattern. Also, the width of conducting tracks forming the pattern, including the stubs, will normally be about 0.3 mm wide, for typical values of the dielectric permittivity of the substrate material on which the coupler is formed. The inventors have realised that such a combline pattern may be conveniently formed using printed circuit techniques, and also that for such a device it is particularly advantageous if the movable component is part of a microelectromechanical system (MEMS). Such a MEMS system offers the possibility of forming a compact, reliable and rugged microwave device incorporating one or more directional couplers. When there are two or more couplers, these may be arranged in parallel or in series. Such a device may also incorporate amplifiers where it is necessary to boost or control the level of one output relative to another. In such a way, it is possible to form an essentially solid state microwave device having a plurality of microwave outputs for which the relative phases can be electronically controlled.

Combline devices may be formed in a configuration which is open on one surface, known as microstrip, and in a configuration which has a dielectric layer on both faces of the coupler, known as stripline. Any mechanical movement of elements of the coupler that is made in order to bring about the desired change in symmetry must be compatible with the microstrip or stripline geometry employed.

Although the relative phases could be controllable by switching between just two different phase values, the invention will be particularly useful if the phase control is such that the phases may be controlled continuously or semi-continuously over a certain range of phases. By semi-continuously, what is meant is that the phase can be changed in at least 5, preferably at least 10, and most preferably at least 100 discrete steps over the adjustment range.

A semi-continuous adjustment may be made by if the movable component when moved is effective to change the dimensions of at least one stub in order to alter relative coupling of microwave energy between the first and second transmission lines. As will be described in more detail below, microwave signals in the first and second transmission lines can be represented as a superposition of what are referred to as even and odd modes in the transmission lines, such superposition being defined as that which corresponds to the signal combination applied to the input ports. Thus, when a signal is input into the first port while no signal is input into the second port, this can be represented by a superposition of even and odd modes that results in a cancellation to zero at the second port. The even and odd modes will, in general have different phase velocities as they travel along the combline pattern, and so the relative phase between the signals on each transmission line will, in general, vary. Of interest to the usefulness of the coupler is the relative phases at the two output ports. The change in the electrical properties between the two transmission lines due to a local change in coupling, for example by changing the dimensions of one stub, will affect the average phase velocities of the even and odd modes and hence the phase differences at the outputs. The more stubs there are having controllable dimensions, the finer the control will be over the relative phase difference at the output ports.

It would, however, be possible to provide essentially continuous control over the phase differences, by providing a movable component which when moved produces a continuous change in the coupling between the first and second transmission lines. For example, the movable component could be arranged to change the spacing between the two transmission lines in order to alter relative coupling of microwave energy between the first and second transmission lines and thereby control the relative phases of said microwave signals.

Alternatively, if each stub extends in a plane, the movable component when moved could be effective to change the relative orientations of adjacent planes of stubs, for example by moving one or more stubs in one transmission line up or down relatively to nearby or adjacent stubs in the opposite transmission line.

Another way to change the coupling would be by means of the variation in a dielectric material that is incorporated in the directional coupler. For example, the combline microwave directional coupler will, in general comprise an electrically conductive ground plane, an insulating dielectric layer, and an electrically conductive patterned layer, the combline pattern being formed by the patterned layer and the dielectric layer being positioned between the ground plane and the patterned layer. The means for altering the symmetry parameter may then be effective to alter the dielectric coupling between the electrically conductive patterned layer and the combline pattern in order to alter relative coupling of microwave energy between the first and second transmission lines and thereby control the relative phases of said microwave signals.

### BRIEF DESCRIPTION OF THE DRAWINGS

The invention will now be further described, by way of example only, and with reference to the accompanying drawings, in which:

FIG. 1 shows schematically a symmetrical combline directional coupler having two transmission lines with a pair of input ports and a pair of output ports and a set of interleaved stubs;

FIG. 2 shows the generation of forward and reverse waves of a single stub pair, between transmission lines;

FIG. 3 shows schematically an asymmetrical combline directional coupler;

FIG. 4 shows the variation of output coupling at the two output ports with frequency for an asymmetrical combline structure of fixed physical length;

FIG. 5 is a schematic representation of the voltages on the two coupled transmission lines that make up the even and odd modes of an asymmetric combline coupler;

FIG. 6 shows schematically a combination of even and odd modes corresponding with inputs at two input ports for the asymmetric combline coupler;

FIGS. 7A-C are plots that show the effect of varying the coupling factor between pairs of stubs, for different symmetry parameters and for various overall coupler lengths expressed in percentages of the beat wavelength;

FIG. 8 shows a family of curves that illustrate the relative phase of the two directional coupler outputs for various values of coupling factor plotted against a range of coupler lengths from zero to a half beat wavelength;

FIG. 9 shows a family of curves that illustrate the relative phase of the two directional coupler outputs for various coupler lengths from zero to a half beat wavelength, plotted against a range symmetry values;

FIGS. 10 and 11 show schematically a combline directional coupler according to a first preferred embodiment of the invention, in which a MEMS cantilever actuator is used to alter the electrical length of individual stubs between two transmission lines;

FIG. 12 shows an enlarged perspective view of the MEMS cantilever actuator of FIG. 11; and

FIG. 13 shows schematically a combline directional coupler according to a second preferred embodiment of the invention, in which a set of MEMS lifting actuators are used to raise and lower a set of groundplane elements above the interleaved stubs.

### DETAILED DESCRIPTION

FIG. 1 shows schematically a symmetrical combline directional coupler 1. This consists of a pair of parallel, microstrip transmission lines 2, 3. Each transmission line includes a narrow elongate conductive section 4, 5, separated by, typically, a distance of several times the width of each section. These sections 4, 5 are coupled by the addition of short, alternately interleaved stubs 6, 7 to form a combline pattern 10. The interleaving of the stubs forms a coupling region in which microwave energy is coupled between the transmission lines 2, 3.

Each transmission line 2, 3 extends between first and second opposite ends 8, 9 of the combline pattern 10. There are four ports 11, 12, 13, 14, one at each end 8, 9 of the transmission lines 2, 3 for coupling microwave signals into or from the transmission lines. At the first end 8 of the combline pattern, there is a first input port 11 to the first transmission line 2, and a second input port 12 to the second transmission line 3. In a typical application, an input signal is only applied to one input port. At the second end 9 of the combline pattern 10, there is third output port 13 to the second transmission line 2 and a fourth output port 14 to the first transmission line 3.

If a microwave signal, represented by curved arrow 15, is input to port 11, the power that emerges 16, 17 from the directional coupler 1 is almost completely divided between the output ports 13, 14, with very little power emerging at port 12. The ratio of the power division between the output ports 13 and 14 depends on the length of the device in wavelengths. Thus, as the frequency is increased from zero, the power at output port 13 increases from zero to a maximum, decreases to zero, rises again, and so on in a sinusoidal fashion. The output at the other output port 14 is the inverse of this.

If the directional coupler 1 is symmetrical, then the phase difference between the signals emerging at ports 13 and 14 is always 90°. If it is asymmetrical (for example, the stub lengths in the coupling region are different on the two transmission lines 2, 3) then the phase difference varies with frequency. The output phase difference between the output signals 16, 17 is therefore dependent on the symmetry of the coupling region.

### 1. Theory of Operation

The combline coupler was first proposed by Gunton and Paige in 1975 [D J Gunton and E G S Paige: ‘Directional coupler for gigahertz frequencies based on the coupling properties of two planar comb transmission lines’, Elec. Lett., 1975, 11, pp 406-8.] as a way of obtaining a high level of coupling (almost 0 dB) in a configuration which did not require close conductor spacings. In this regard, it was a step forward from the conventional ‘edge-coupler’, in which high coupling levels required very close conductor spacings and for which 0 dB was not possible, in principle, while a coupling level of −3 dB was a technology challenge. A general theory [D J Gunton and E G S Paige: ‘An analysis of the general asymmetric directional coupler with non-mode-converting terminations’, IEE J Micr., Opt, and Acoust., 1978, 2,1, pp 31-6] and a description of very wideband operation [D J Gunton: ‘The design of wideband codirectional couplers and their realisation at microwave frequencies using coupled comblines’, IEE J Micr., Opt, and Acoust, 1978, 2,1, pp 19-30] has also been presented.

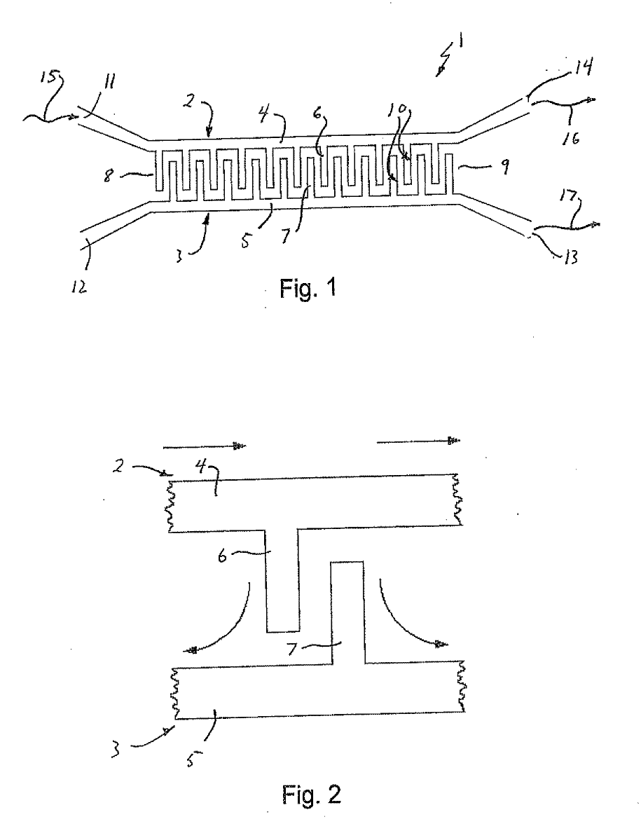

The combline coupler has a different operational principle from the edge-coupler. The basic coupling element, the stub pair, shown in FIG. 2, results in bi-directional coupling. The majority of a signal incident at port 11 will be transferred to port 14, while the small portion which is coupled to the adjacent transmission line will be equally divided between ports 12 and 13. The coupling is predominantly through the electric field, so that no directional information is transferred, and continuity of fields requires that both a forward and a reverse wave are generated in the adjacent transmission line.

In the case of the combline coupler, a series of coupling elements (stub pairs) results in a gradual increase in the coupled signal along the length of the device towards port 13 (because the contributions from successive stub pairs add in phase), whereas the signal in the reverse direction (towards port 12) remains small. That signal varies along the coupled region between a small value and zero in a sinusoidal fashion. Such devices are referred to as forward couplers.

As noted above, the coupled signal towards port 13 grows with distance (or, equivalently, the output at port 13 grows with increasing frequency). However, that output eventually reaches a maximum and then reduces to zero, before rising again in a sinusoidal fashion. The signal towards port 14 starts at the input value, and then decreases to a minimum before rising again.

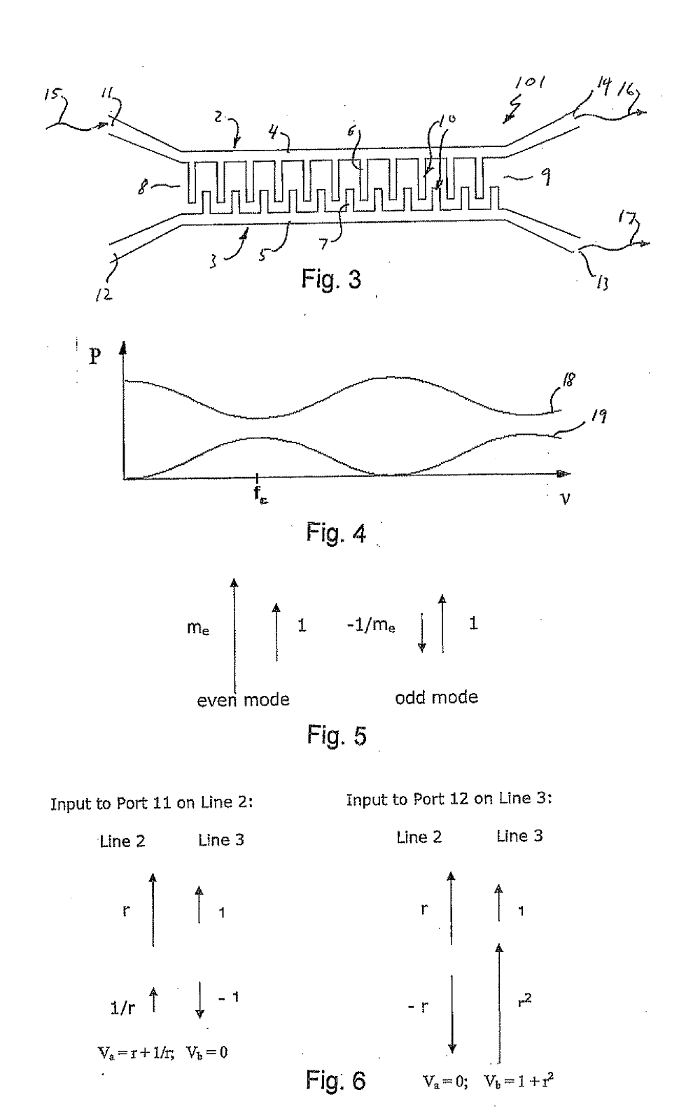

If the coupler geometry is symmetrical, then the coupled signal rises to 100% of the input level, apart from losses in the coupler materials and the small amount of power emerging at port 12. When the coupler 101 is asymmetrical, for example as shown in FIG. 3, that maximum is less than 100%, and the corresponding minimum in the signal travelling towards port 14 is greater than zero. In FIG. 3, for convenience the same reference numerals are used to indicate features similar to those of FIG. 1. The power 18 of the output signal 17 at the third output port 13 and the power 19 of the output signal 16 at the fourth output port 14 are illustrated in FIG. 4.

A more detailed approach to a description of the operation is obtained by considering the normal modes (or eigenvectors) of the coupler. As with any coupled system, there are particular ways of exciting it such that there is no net energy transfer between the coupled elements. Any arbitrary excitation may then be decomposed into a linear combination of these modes, and the subsequent behaviour of the system is obtained by evaluating the vector sum of the modes as they propagate.

The following description is based on the assumption that the coupler is lossless and that all of the input power (at port 11) appears at ports 13 and 14. This is a reasonable approximation for the illustrative purposes of the following description.

### 1.1 Symmetrical Coupler

It can be shown experimentally and theoretically that if equal and co-phased signals are applied at ports 11 and 12 of the symmetrical coupler 1, then these signals will propagate along the coupled region maintaining that amplitude and phase relation, and with a characteristic velocity vₑ. This mode of excitation is referred to as an even mode, and its velocity as the even mode velocity. If equal amplitude but anti-phase inputs are applied to ports 11 and 12, then they will also propagate without changing their relationship. They together constitute the odd mode, with a characteristic velocity vₒ. The odd and even mode velocities are different, so that when both are present the energy on the two coupled lines will vary with distance as the phase relationship between the modes changes.

It is apparent that an input applied only to port 11 can be represented by a combination of the even and odd modes present equally, so that the voltages at port 12 sum to zero. As the modes propagate, there is a position along the coupled region (provided that it is long enough) at which the relative phase between the modes has increased by 180°. At this point there is cancellation on line 2 and reinforcement on line 3: all of the energy has transferred to line 3. At greater distances, as the process continues, the energy returns to line 2. The distance at which full transfer takes place will be shorter at higher frequencies, and, as noted above, the operation can equivalently be described by maintaining the coupling length constant and varying the frequency.

It is useful to define the ‘beat wavelength’ λ_{b}, which is the distance at which the coupled power has risen to a first maximum and then returned to zero. This is seen to be when the phase difference between the modes is 360° so that, at a frequency f,

λ_{b}=vₑ·vₒ/f(vₑ−vₒ) (1)

The peak in the coupled power occurs at half the beat wavelength.

Consequently, for a given length of coupled line l, the frequency corresponding to the first maximum in the coupled power, f_{c}, is given by

f_{c}=½vₑ·vₒ//(vₑ−vₒ), (2)

and f_{c} is referred to as the centre frequency of the coupler.

By considering the vector sum of the modes, the coupled power, at a distance/along the coupler and at a frequency f, can be shown to be sin² θ, for unit input power, where θ, the phase difference between the modes, is given by 2πf/(vₑ−vₒ)/vₑ·vₒ. The power on the input line varies as cos² θ.

The sinusoidal behaviour with the variable fl is immediately apparent. A more useful way to express the variable θ is Δβl, where Δβ is the difference in the phase constants of the modes, βhd e−βₒ and βₑ=2πf/vₑ, βₒ=2πf/vₒ. This notation allows the behaviour of the coupler to be easily understood as changes are made to the two propagation modes as a result of changes to geometry and symmetry.

The phase difference between the outputs is, for the case of the symmetrical coupler, 90° for all values of θ.

### 1.2 Asymmetric Coupler

The even and odd modes again have different velocities, but the voltage vectors which constitute those modes no longer have the relationship of +1 and −1 that are found in the symmetric coupler.

Let the voltage ratio for the even mode be mₑ and for the odd mode be mₒ. It can be shown that, for conservation of energy, mₑ·mₒ=−1. These modes are shown schematically in FIG. 5.

If the coupled lines are referred to as a and b (with ports 11 and 13 at each end of line a) then the even mode can be written as the voltage ratio Vₐₑ/V_{be}, and the odd mode as Vₐₒ/V_{bo}. Thus, Vₐₑ/V_{be}=mₑ and Vₐₒ/V_{bo}=−1/mₑ, based on the relationship noted above. It is convenient to use a single parameter r, where r=mₑ, to describe the voltage ratios of the modes.

With this notation, an input to port 1 only can be represented as the sum of Vₐₑ=r, V_{be}=1 and Vₐₒ=1/r, V_{bo}=−1, or 1×(even mode)−1×(odd mode). As a result, Vₐ=r+1/r and V_{b}=0.

An input to port 2 only is represented by Vₐₑ=r, V_{be}=1 with Vₐₒ=−r, V_{bo}=r², or 1×(even mode)+r×(odd mode). As a result, Vₐ=0 and V_{b}=1+r². These two cases are illustrated in FIG. 6.

Based on the mode distribution shown above, the appropriate vector sums can be performed to provide expressions for the coupled power variation, and the output phase difference.

The following description uses S-parameter notation in which the first to fourth ports 11-14 are identified respectively by subscripts numbered 1, 2, 3 and 4. Thus, for unit inputs, S₂₁ is the output at the second port 12 when the input is at the first port 11, and S₁₁ is the output at the first port 11 when the input is at the first port 11—i.e. the amount reflected back.

After normalising for unit input power at the first port 11, the output power at the third port 13 is given by:

|S₃₁|²=4r² sin² θ/2/(1+r²)². (3)

The output power at the fourth port 14 is then (for unit input power at the first port 11 and assuming lossless conditions and no reverse coupling):

|S₄₁|²=1−|S₃₁|². (4)

Equation (4) may alternatively be written as:

|S₄₁|²=[1−r²)/(1+r²)]²+4r² cos² θ/2/(1+r²)²,

which shows the cos² nature of the variation.

It is useful to refer to the maximum coupled power as the coupling factor C, which lies in the range zero to unity, given by

C=4r²/(1+r²)². (5)

Conversely, the symmetry parameter r, for a given value of C, is given by

r²=(2/C)[1+(1−C)^{1/2}]−1. (6)

The phase difference between the outputs is given by:

Δφ₁=tan⁻¹[sin θ/(r²+cos θ)]+90°−θ/2. (7)

(This expression reduces to Δφ₁=90° for the special case of r=1.)

For unit input power at the second port 12, the power distribution expressions are identical (i.e. |S₄₂|²=|S₃₁|² and |S₃₂|²=|S₄₁|²), but the phase difference is 180° different:

Δφ₂=180°−Δφ₁. (8)

It is expressions (7) and (8) for phase difference at the coupler outputs 13, 14, their dependence on θ, r and C, which will be considered in more detail Section 2 below.

### 1.3 Coupler Symmetry

The main feature which indicates the symmetry of a combline coupler is its geometry, notably the relative lengths of the stubs. Strictly, it is the coupled phase velocities on the two coupled transmission lines which must be compared.

The coupled phase velocities are not the same as the mode velocities. An isolated (or uncoupled) transmission line has a phase velocity associated with it. The addition of stubs to a uniform microstrip line will modify the velocity of propagation along it, through the introduction of additional loading (mainly capacitative). We define the uncoupled phase constant βᵤ; when the line is coupled to another transmission line the phase constant is modified by the magnitude of the coupling coefficient k, and the coupled phase constant is related to k by

β_{c}βᵤ+k

For the general coupler, β_{c1} and β_{c2} are the coupled phase constants for the two coupled transmission lines, and the mode symmetry parameter m is dependent on these. If β_{c1}=β_{c2} then the coupler is symmetrical and r=1.

There are various ways in which β_{c1} and β_{C2} can be different. Examples are as follows.
Dissimilar stub dimensions
Different widths of transmission line elongate section
Different dielectric properties beneath each transmission line
Addition of stubs to the outside of the elongate section (herringbone pattern)
Forming the coupler around a curve
Resonance or length-dependent effects at particular frequencies.

Clearly, some of these are more amenable to dynamic change than others.

### 2. Calculations and Practical Operating Options

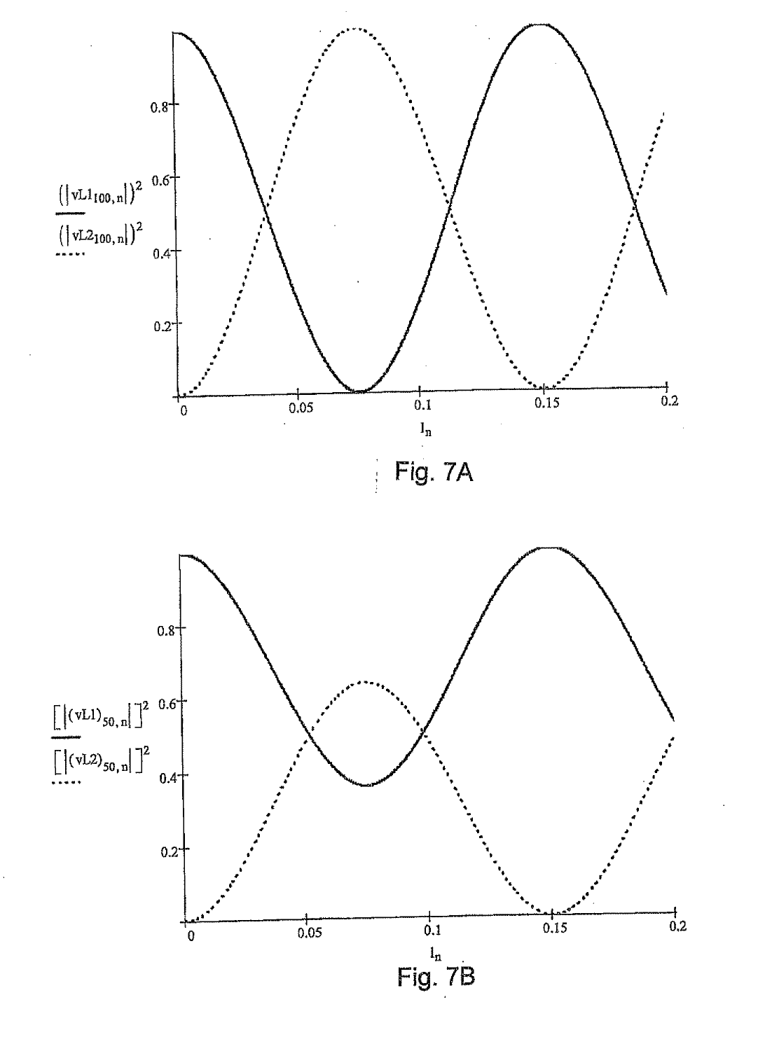

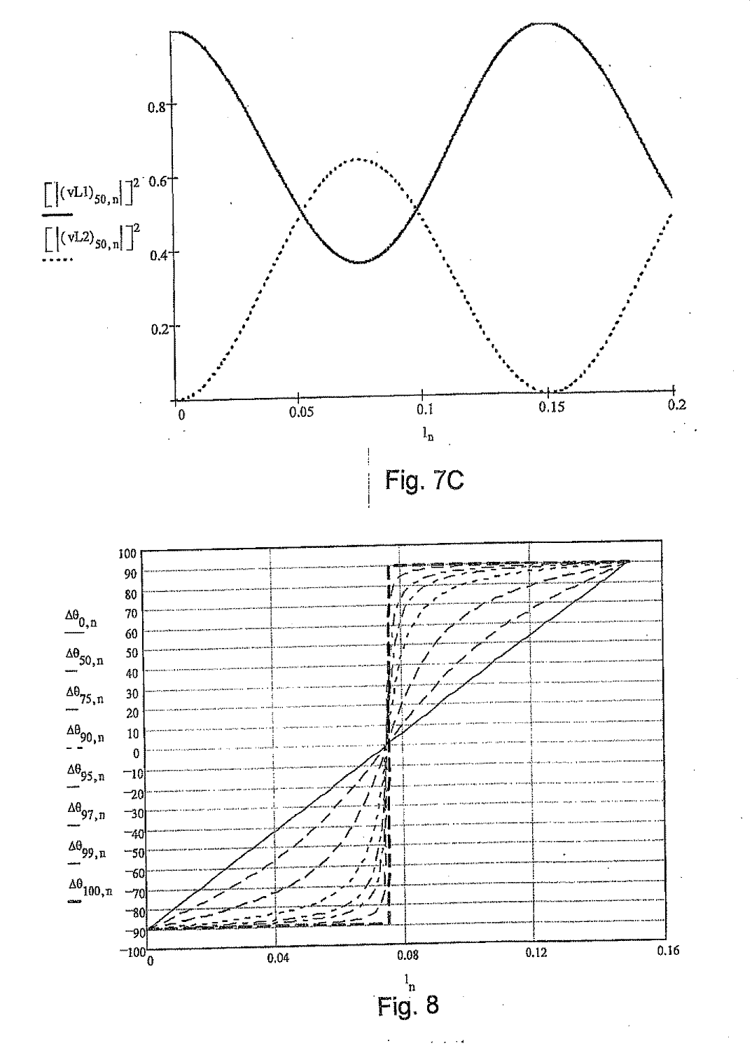

The effect of the coupling on the power levels for each line, at various points along the transmission line elongate section, can be seen in FIGS. 7A, 7B and 7C, which show the effect of varying the coupling factor between pairs of stubs, for various overall coupler lengths expressed in percentages of the beat wavelength λ_{b}.

For a symmetry parameter r=1.0, FIG. 7A illustrates the power ratios reaching 100% and zero coincidentally on the two lines, this power ratio alternating between the two lines each half of a beat wavelength. FIG. 7B illustrates that with a symmetry parameter r=0.5 the peak power is at 64% of the input, while FIG. 7C shows that with a symmetry parameter r=0.41 an equal power split can be achieved.

FIG. 8 shows a family of curves that illustrate the relative phase of the two outputs for various values of coupling factor plotted against a range of coupler lengths from zero to a half beat wavelength. The vertical axis of FIG. 8 shows the phase difference at the output ports 13, 14, and the horizontal axis shows the transmission line length for a coupler with a beat wavelength of 0.015 m. The numerical suffix on the Δθ labels indicates the coupling factor as a percentage. These results would, of course, apply for any span of multiple half wavelengths.

FIG. 8 shows that if the coupler is symmetrical (heavy dashed curve), so that there is complete power transfer, then the phase difference is −90° at lengths less than half the beat wavelength, and +90° above it. The transition is abrupt, and corresponds to the power on the input line being zero: when the power begins to rise again it does so with a phase that is 180° different from before. If the lines are highly asymmetrical, so that the level of the coupled power is very low (solid curve), then the phase difference between the outputs varies linearly. At intermediate values of symmetry, the transition between −90° and +90° takes place in a non-linear fashion. Of significance to the present investigation is the fact that the variation of phase difference with symmetry can be rapid close to the a symmetry value of unity and close to the centre frequency. It reduces at frequencies further from the centre frequency and at symmetries further from unity.

When the symmetry is close to unity, however, the difference between the coupled and direct power levels is very great near to the centre frequency, and therefore this region of the curves has limited benefit for an electronic phase shifter application.

However, a more promising region is to be found at around 80% of the centre frequency, where a change in the symmetry parameter between 0.9 and 0.45 will result in an output phase variation of 45°.

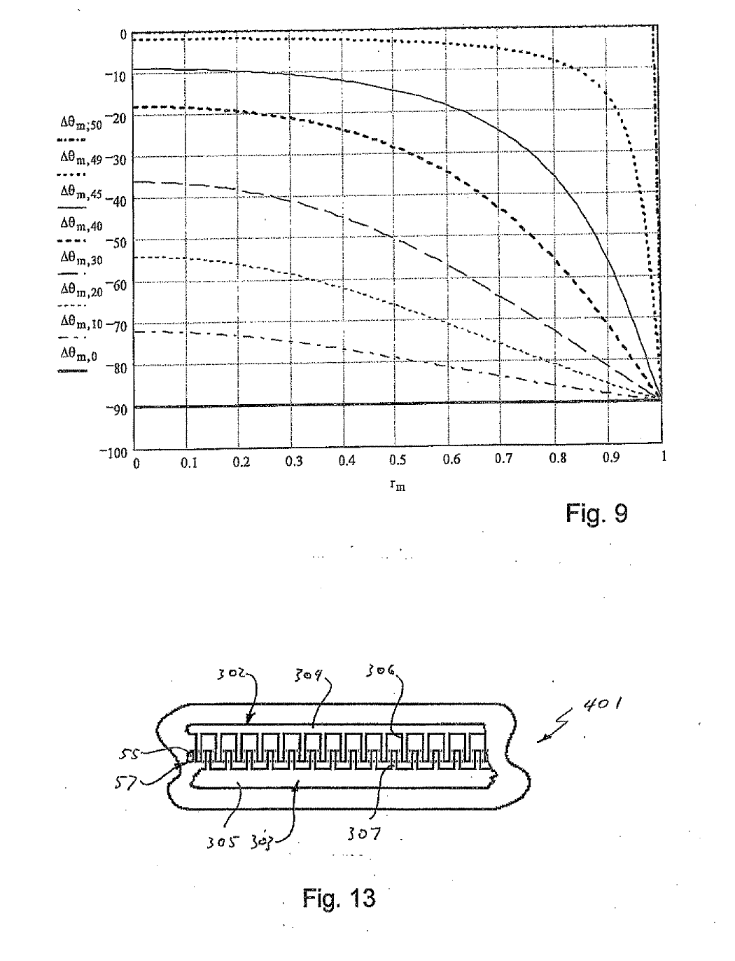

This result may also be deduced from FIG. 9, which presents the phase calculations in an alternative representation. Here, the variation of the output phase difference is shown plotted against the symmetry parameter r, for various coupler lengths from zero to a half beat wavelength. Again, for a symmetrical coupler the phase difference is seen to be always 90°. At the 80% point (equivalent to 40% of the beat wavelength in FIG. 8), a variation in symmetry between 0.45 and 0.9 gives a 45° phase change.

For these curves, it can be seen that there are some regions in which is more desirable to operate, depending on the amount of phase variation required in any particular application, and depending on the relative power required at the coupler outputs.

For example, assume that an approximately equal power division is required, i.e. the operation is to be around the −3 dB points on the coupler characteristics. This can be achieved in two ways. One is to operate with a coupler that is close to being symmetrical, and to choose a length/frequency combination which corresponds to the curves crossing at a steep slope. In this approach, the operating bandwidth may limited, but 10% is feasible. This corresponds to the region in FIG. 8 around l=0.04 or 0.12, and close to the upper right and lower left of the figure, where the r values are around 0.9.

Another possibility is to operate around the centre frequency, with a symmetry chosen to give an approximately equal power division. This will have the benefit of a greater bandwidth (say, 30%). In FIG. 8, this is in the vicinity of l=0.08, and relatively close to the centre of the diagram, where the r values are around 0.5.

It is relevant to recognise an additional consideration when the change in symmetry is being produced by the movement of some of the stubs in the device, for example when using a microelectromechanical system (MEMS) technique. The act of changing the symmetry by changing the geometry is likely to reduce the coupling between the two transmission lines. As a result, the centre frequency will increase. The apparent effect of this will be to cause the power division to be degraded. However, if the upper of the two possible regions is chosen (around l=0.12 in FIG. 8), then there will be some degree of compensation, although the extent of this will depend on the actual parameters of the device.

The two approaches described above can be seen to result in changes in the output phase difference of around 20°, for changes in the symmetry parameter of 0.2 to 0.4. The skilled person will appreciate that the exact value of phase change will depend on the construction techniques, and how large the physical changes are that can be brought about by the MEMS control.

An alternative approach to the design, if larger phase changes are required, is as follows. Operation near to the centre frequency of a device in which the symmetry parameter is near to unity (e.g. r=0.9) can result in relatively large phase changes for a small change in symmetry. FIG. 8 indicates that around 60° or more should be possible. The potential disadvantage of this is that the power levels at the two outputs are different, possibly by as much as 10 dB. Thus, it may be necessary to use an amplifier (or an attenuator) in one output if an equal power split is required.

As will be appreciated by the person skilled in the art, for any given is application, there will be an optimum operating region, in which phase variation, bandwidth and power division are traded off.

### 3. Implementation Using MEMS Technology

Variation of coupling may be implemented in various ways and three examples are given below. It is worth noting at the outset that the overall behaviour of a coupler is based on distributed effects. Thus, if at a local level it is only possible to have a binary change, an overall intermediate value of a parameter (symmetry, for example) can be obtained by a combination of local ones with an appropriate distribution of the bipolar states.

### 3.1 Stub Length MEMS Actuator

Another technique uses MEMS switches to increase the stub lengths on the combline and hence to alter the coupling between the transmission lines. This is best suited to microstrip circuits, as illustrated schematically in FIGS. 11 and 12.

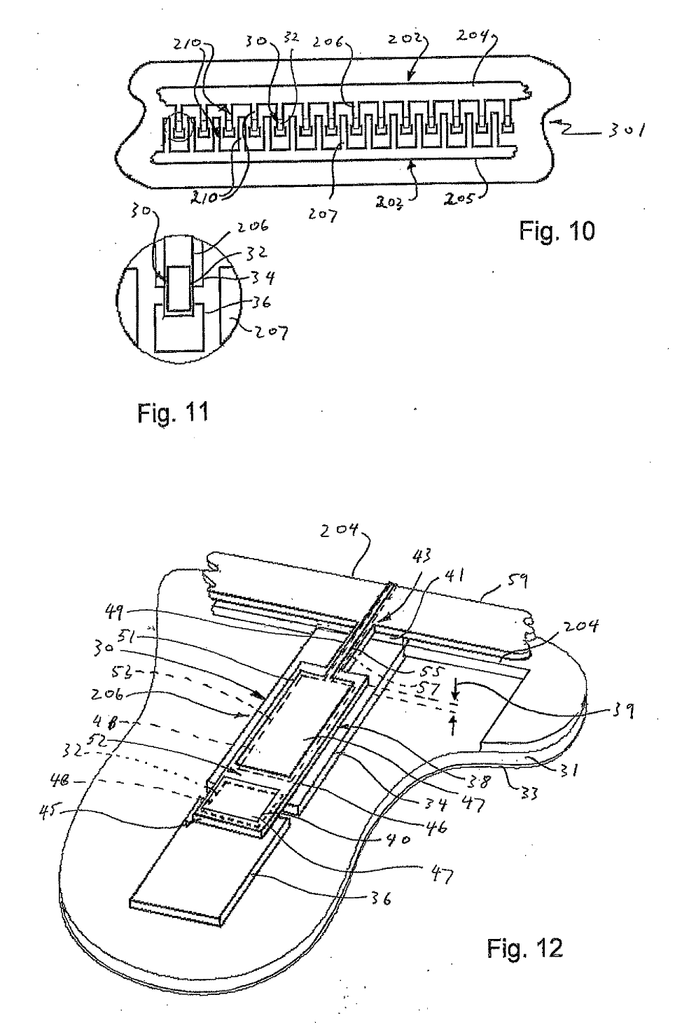

FIG. 10 shows a simplified schematic drawing of a combline direction coupler 301 having a pair of asymmetric transmission lines 202, 203, one of which 202 has individual MEMS switch actuators 30 at each one of a plurality of stubs 206 extending from an elongate conducting section 204 of the transmission line 202. As shown in FIG. 11, each actuator 30 can be individually controlled in order to close an electrical connection 32 between a primary section 34 of a corresponding stub 206 closest to the elongate section 204, and a secondary portion 36 of the same stub 206 farthest from the elongate section 204 and nearest an elongate section 205 of the opposite transmission line 203. Each stub 206 therefore comprises the primary stub portion 34, and optionally also the secondary stub portion 36, depending on the state of the actuator 30. Therefore, by closing the electrical connection 32, the electrically contiguous length of the stub 206 is increased. As explained above, this will affect the average coupling between the transmission lines, and so will effect a change in the relative phases at the directional coupler outputs.

FIG. 12 shows the one stub 206 of the combline pattern 210 and one of the MEMS switch actuators 30 in more detail. The combline pattern is formed on a dielectric substrate 31. An opposite side of the substrate is plated with a metal groundplane 33.

The MEMS switch actuators 30 incorporate flexible planar cantilever beams 38, which in a relaxed orientation are each separated from a corresponding stub 206 by a gap 39, set by a spacing element 41 at a fixed end 43 of the beam 38. An opposite free end 45 of the beam 38 moves relatively up and down with respect to the stub 206, when actuated, in order to close the electrical connection 32, which is here a metal contact pad. Each beam 38 is fabricated as a symmetrical three-layer structure, formed by a central dielectric layer 46 an upper metallic layer 47 and a lower metallic layer 48 (shown in phantom outline). The symmetrical structure minimises or eliminates distortions due to changes in temperature or humidity.

The beam has a waist 49 that serves as a primary flexing region, and has a break 52 in the upper and lower layers near the free end 45 to define in the lower layer 46 nearest the free end 45 the contact pad 32 which, when the switch is actuated, links the primary and secondary stubs 34, 36 electrically. The break 52 also defines in the upper layer 46 an upper pad 40 that is aligned with the contact pad 32, as well as defining upper and lower actuator pads 51, 53 in the upper and lower layers 46, 47 between the break 42 and the waist 49. The upper and lower actuator pads 51, 53 are electrically connected together. This may be done in different ways. In this example, the actuator pads 51, 53 are connected, respectively, to upper and lower electrical circuit traces 55, 57, also formed in the corresponding upper and lower metallic layers 47, 48. The electrical connections are joined together at an edge 59 of the dielectric layer 46. Although not illustrated, another way in which these actuator pads may be connected is by means of vias plated through a one or more holes in the dielectric layer 46.

A DC actuating voltage is individually applied through connections (not shown) to upper and lower electrical circuit traces 55, 57 to the upper and lower actuator pads 51, 53 of each actuator as required, while the common return is through the metal primary stub 34 and line 204. The beam therefore bends under the electrostatic attraction between the primary stub 34 and lower actuator pad 53. It is advisable to provide an RF choke, using known techniques, to isolate the microwave energy from the DC circuit.

The primary stub will therefore ultimately become electrically lengthened by the action of the switch 30.

### 3.2 Groundplane Retraction MEMS Actuator

In this embodiment, the coupling is varied by retracting the groundplane at the ends of the stubs as illustrated in FIG. 13. One particular advantage of this technique is that stripline implementation is possible as the variable component is outside the circuit.

This embodiment uses a stripline directional coupler circuit 401 having upper and lower groundplanes. The lower groundplane is fixed, as is most of the upper groundplane, apart from a central elongate strip, the location of which is illustrated by dashed line 52 which is parallel with and positioned between the elongate sections 304, 305 of each transmission line 302, 303. The central upper ground plane strip is always electrically connected to the rest of the upper ground plane, but can be moved towards or away from the interleaved stubs 306, 307, which it partially overlaps. The movement is provided by piezo-electric actuators 55 at opposite ends 57 of the central strip 52.

The actuators may therefore be piezo, as in FIG. 13, or electrostatic, as in FIG. 12. More variability is possible if the upper ground plane does not have a whole strip removed, but has a series of holes (e.g. rectangular) in the vicinity of the overlap regions of the fingers, and then a set of individually-controlled actuators causes metal plates to cover selected holes. The metal plates could be part of the actuators, as in FIG. 12.

The two embodiments discussed above are most suitable to for use in the millimetre microwave band, as this results in a coupler having components with dimensions which are most suitable for a MEMS actuator to modify or alter to create a useful phase change at the two coupler outputs.

The invention therefore provides a convenient microwave directional coupler having a variable phase delay at a pair of output ports.

1-17. (canceled)

18. A combline microwave directional coupler, comprising:
a first and a second transmission line, wherein each transmission line includes along its length a series of stubs, the stubs of the first and second transmission lines being oriented in a combline pattern with each other such that in use microwave energy passing along one transmission line is coupled to the other, and the transmission lines extending between a first end of the combline pattern and an opposite second end of the combline pattern;
a port at each end of the transmission lines to couple microwave signals into or out of the transmission lines, including at the first end of the combline pattern a first input port to the first transmission line, and a second input port to the second transmission line, and including at the second end of the combline pattern a third output port to the first transmission line and a fourth output port to the second transmission line, wherein a phase difference between the signals appearing at the output ports is characteristic of a symmetry parameter of the transmission lines related to the difference in the propagation characteristics of microwave energy in the two coupled transmission lines; and
an altering arrangement to alter the symmetry parameter to control the relative phases of microwave signals coupled out of the two ports at the second end of the combline structure when a microwave signal is coupled into one of the ports at the first end of the combline structure.

19. The combline microwave directional coupler according to claim 18, wherein at least some of the stubs extend from one transmission line towards the other transmission line.

20. The combline microwave directional coupler according to claim 19, wherein at least some of the stubs extending from the first transmission line towards the second transmission line are interleaved with other stubs extending from the second transmission line towards the first transmission line to form an interleaved combline pattern.

21. The combline microwave directional coupler according to claim 20, wherein the interleaved stubs are alternately interleaved.

22. The combline microwave directional coupler according to claim 18, in which at least some of the stubs extend from at least one of the transmission lines in a direction away from the other transmission line to form a herringbone combline pattern.

23. The combline microwave directional coupler according to claim 18, wherein the combline microwave directional coupler includes at least one movable component which in use is electromagnetically coupled with microwave energy in one or both of the transmission lines, and the altering arrangement for altering the symmetry parameter is a mechanical arrangement for moving the movable component in order to alter relative coupling of microwave energy between the first and second transmission lines and thereby control the relative phases of the microwave signals.

24. The combline microwave directional coupler according to claim 23, wherein the movable component is part of a microelectromechanical system (MEMS).

25. The combline microwave directional coupler according to claim 23, wherein the movable component when moved is effective to change the dimensions of at least one stub in order to alter relative coupling of microwave energy between the first and second transmission lines and thereby control the relative phases of the microwave signals.

26. The combline microwave directional coupler according to claim 24, wherein the movable component when moved is effective to change the dimensions of at least one stub in order to alter relative coupling of microwave energy between the first and second transmission lines and thereby control the relative phases of the microwave signals.

27. The combline microwave directional coupler according to claim 23, wherein each stub extends in a plane, and the movable component when moved is effective to change the relative orientations of adjacent planes of stubs.

28. The combline microwave directional coupler according to claim 24, wherein each stub extends in a plane, and the movable component when moved is effective to change the relative orientations of adjacent planes of stubs.

29. The combline microwave directional coupler according to claim 23, wherein the movable component when moved is effective to change the spacing between the transmission lines in order to alter relative coupling of microwave energy between the first and second transmission lines and thereby control the relative phases of the microwave signals.

30. The combline microwave directional coupler according to claim 24, wherein the movable component when moved is effective to change the spacing between the transmission lines in order to alter relative coupling of microwave energy between the first and second transmission lines and thereby control the relative phases of the microwave signals.

31. The combline microwave directional coupler according to claim 18, further comprising:
an electrically conductive ground plane;
an insulating dielectric layer; and
an electrically conductive patterned layer;
wherein the combline pattern is formed by the patterned layer and the dielectric layer being positioned between the ground plane and the patterned layer, and the altering arrangement for altering the symmetry parameter is effective to alter the dielectric coupling between the electrically conductive patterned layer and the combline pattern in order to alter relative coupling of microwave energy between the first and second transmission lines and thereby control the relative phases of the microwave signals.

32. A microwave circuit, comprising:
a source of microwave energy; and
a combline microwave directional coupler, which includes:
a first and a second transmission line, wherein each of the transmission lines includes along its length a series of stubs, the stubs of the first and second transmission lines being oriented in a combline pattern with each other such that in use microwave energy passing along one transmission line is coupled to the other, and the transmission lines extending between a first end of the combline pattern and an opposite second end of the comb line pattern,
a port at each end of the transmission lines to couple microwave signals into or out of the transmission lines, including at the first end of the combline pattern a first input port to the first transmission line, and a second input port to the second transmission line, and including at the second end of the combline pattern a third output port to the first transmission line and a fourth output port to the second transmission line, wherein a phase difference between the signals appearing at the output ports is characteristic of a symmetry parameter of the transmission lines related to the difference in the propagation characteristics of microwave energy in the two coupled transmission lines, and
an altering arrangement to alter the symmetry parameter to control the relative phases of microwave signals coupled out of the two ports at the second end of the combline structure when a microwave signal is coupled into one of the ports at the first end of the combline structure;
wherein the first port is configured to receive microwave energy from the source of microwave energy.

33. The microwave circuit according to claim 32, wherein the source of microwave energy is a millimeter band source of microwave energy.

34. A phased array radar system, comprising:
a radar transmitter having at least two transmitting elements for transmitting radar signals; and
at least one combline microwave directional coupler which includes:
a first and a second transmission line, wherein each of the transmission lines includes along its length a series of stubs, the stubs of the first and second transmission lines being oriented in a combline pattern with each other such that in use microwave energy passing along one transmission line is coupled to the other, and the transmission lines extending between a first end of the combline pattern and an opposite second end of the comb line pattern,
a port at each end of the transmission lines to couple microwave signals into or out of the transmission lines, including at the first end of the combline pattern a first input port to the first transmission line, and a second input port to the second transmission line, and including at the second end of the combline pattern a third output port to the first transmission line and a fourth output port to the second transmission line, wherein a phase difference between the signals appearing at the output ports is characteristic of a symmetry parameter of the transmission lines related to the difference in the propagation characteristics of microwave energy in the two coupled transmission lines, and
an altering arrangement to alter the symmetry parameter to control the relative phases of microwave signals coupled out of the two ports at the second end of the combline structure when a microwave signal is coupled into one of the ports at the first end of the combline structure;
wherein the transmitting elements are connected to different output ports of the at least one directional coupler so that in use the direction of radar signals transmitted by the transmitting elements can be controlled by controlling the relative phases of the microwave signals coupled out of the output ports.
